(19) United States
(12) Patent Application Publication
(10) Pub. No.: US 2010/0074649 A1
(43) Pub. Date: Mar. 25, 2010

(54) IMAGE-FORMING DEVICE HAVING PHOTOSENSITIVE DRUM AND LED ARRAY

(75) Inventor: Hakudai KONDO, Nagoya-shi (JP)

Correspondence Address: Scully, Scott, Murphy &Presser, P.C., 400 Garden City Plaze, Suite 300, Garden City, NY, 11530, US

(73) Assignee: BROTHER KOGYO KABUSHIKI KAISHA, Aichi-ken (JP)

(21) Appl. No.: 12/484,504

(22) Filed: Jun. 15, 2009

(30) Foreign Application Priority Data
Sep. 22, 2008 (JP) 2008-243103

(51) Int. Cl. G03G 21/18

(52) U.S. Cl. 399/113

(57) ABSTRACT

An image forming device capable of attaching and detaching a process cartridge to and from a frame without moving an LED array when a door is open. The process cartridge includes a first casing supporting a photosensitive drum and a developing roller, and a second casing pivotally movably connected to the first casing and supporting a charger. The second casing is pivotally movable between a first position in which the charger is positioned close to the LED array for image forming operation, and a second position in which the charger is remote from the LED array in accordance with push-in and pull-out movement of the first casing relative to the frame.

### CROSS REFERENCE TO RELATED APPLICATION

This application claims priority from Japanese Patent Application No. 2008243103 filed Sep. 22, 2008. The entire content of the priority application is incorporated herein by reference.

### TECHNICAL FIELD

The present invention relates to an image forming device, and more particularly, to an electrophotographic type image forming device having a photosensitive drum and an LED array.

### BACKGROUND

An electrophotographic tape image forming device generally includes a photosensitive drum, a charge unit, an LED array, and a developing unit. The charge unit is adapted for uniformly charging a surface of the photosensitive drum. The LED array is adapted for forming an electrostatic latent image on the charged surface of the photosensitive drum. The developing unit is adapted for forming a visible developer agent image with charged developer agent at the electrostatic latent image. The visible image is then transferred onto an image recording medium such as a sheet, so that the visible image can be formed on the sheet.

In such a conventional image forming device, a process cartridge is detachably provided to a frame of the device. The process cartridge accommodates therein the photosensitive drum, the charge unit, and the developing unit. The process cartridge can be exchanged with a new process cartridge upon consumption of developer agent or upon degradation of the photosensitive drum. In order to perform such exchange, one of the photosensitive drum, the charge unit and the developing unit may be mechanically interfered with the LED array such as an LED. Such interference may occur easily in a front access type image forming device in which the frame has a front side provided with a cover, and the process cartridge can be detached from the frame through a front opening after opening the cover.

### SUMMARY

However, operating position of the LED array may be varied in accordance with a repeated retracting movement of the LED array, which degrades imaging quality.

It is therefore an object of the present invention to provide an image forming device facilitating detachment of the process cartridge without any movement of the LED array when the door is open.

This and other objects of the invention will be attained by providing an image forming device including a frame, a process cartridge, and au LED array. The frame has a front opening provided with a door. The process cartridge is detachably assembled in the frame and is accessible through the Font opening upon opening the door. The process cartridge includes a first casing, a photosensitive drum, a second casing, a charger, and a developing roller. The first casing is movably supported by the frame and has a seat portion. The photosensitive drum is disposed in the first casing and has an outer surface in which an electrostatic latent image is formable. The second casing is pivotally movably connected to the first casing and is movable between a first position and a second position in accordance with push-in and pull-out movement of the first casing relative to the frame. The charger is disposed in the second casing for uniformly charging the photosensitive drum. The developing roller is disposed in the first casing for supplying charged developer agent to the photosensitive drum. The LED array is supported to the frame and is provided independent of the first casing and second casing for forming an electrostatic latent image on the photosensitive doll after the photosensitive drum is charged by the charger. The charger is positioned close to the LED array in the first position for image forming operation, and the charger is remote from the LED array in the second position for avoiding mechanical interference therewith. At least one of the second casing and the charger is seated on the seat portion in the second position.

In another aspect of the invention, there is provided an image forming device including a frame, a process cartridge, a secondary cartridge case, a charger, and an LED array. The frame has a front opening provided with a door. The process cartridge is detachably assembled in the frame and is accessible through the front opening upon opening the door. The process cartridge includes a casing, a photosensitive drum, and a developing roller. The casing is movably supported by the frame. The photosensitive drum is disposed in the casing and has an outer surface in which an electrostatic latent image is formable. The developing roller is disposed in the casing for supplying charged developer agent to the photosensitive drum. The secondary cartridge case is separate from the casing and is detachably assembled in the frame and is accessible through the front opening upon opening the door. The charger is disposed in the secondary cartridge case for uniformly charging the photosensitive drum. The LED array is disposed in the secondary cartridge case for forming an electrostatic latent image on the photosensitive drum after the photosensitive drum is charged by the charger

In still another aspect of the invention, there is provided a process cartridge to be detachably assembled in an image forming device having a frame and an LED array supported to the frame. The frame has a front opening provided Wraith a door. The process cartridge is detachably assembled in the frame and is accessible Through the front opening upon opening the door. The process cartridge includes a fist casing, a photosensitive drum, a developing roller, a second casing, and a charger. The first casing is movably supported by the frame and has a seat portion. The photosensitive drum is disposed in the first casing and has an outer surface in which an electrostatic latent image is formable. The developing roller is disposed in the first casing for supplying charged developer agent to the photosensitive drum. The second casing is pivotally movably connected to the first casing and is movable between a first position and a second position. The charger is disposed in the second casing for uniformly charging the photosensitive drum. The charger is positioned close to the LED array in the first position for image forming operation, and the charger is remote from the LED array in the second position for avoiding mechanical interference therewith. At least one of the second casing and the charger is seated on the seat portion in the second position.

In still another aspect of the invention, there is provided a combination of a process cartridge and a secondary cartridge to be detachably assembled in an image forming device having a frame. The frame has a front opening provided with a door. The process cartridge includes a casing, a photosensitive drum, and a developing roller. The casing is movably supported by the frame and is detachably assembled in the frame and is accessible through the front opening upon opening the door. The photosensitive drum is disposed in the casing and has an outer surface in which an electrostatic latent image is formable. The developing roller is disposed in the casing for supplying charged developer agent to the photosensitive drum. The secondary cartridge includes a secondary cartridge case, a charger, and an LED array. The secondary cartridge case is separate from the casing and is detachably assembled in the frame and is accessible through the front opening upon opening the door. The charger is disposed in the secondary cartridge case for uniformly charging the photosensitive drum. The LED array is disposed in the secondary cartridge case for forming an electrostatic latent image on the photosensitive drum after the photosensitive drum is charged by the charger.

### BRIEF DESCRIPTION OF THE DRAWINGS

In the drawings,

FIG. 1 is a schematic vertical cross-sectional view of an image forming device according to a first embodiment of the present invention;

FIG. 2(A) is a schematic view of a process cartridge in its operating position according to the first embodiment;

FIG. 2(B) is a schematic view of the process cartridge in its detaching or attaching state according to the first embodiment; and

FIG. 3 is a schematic vertical cross-sectional view of an image forming device according to a second embodiment of the present invention.

### DETAILED DESCRIPTION

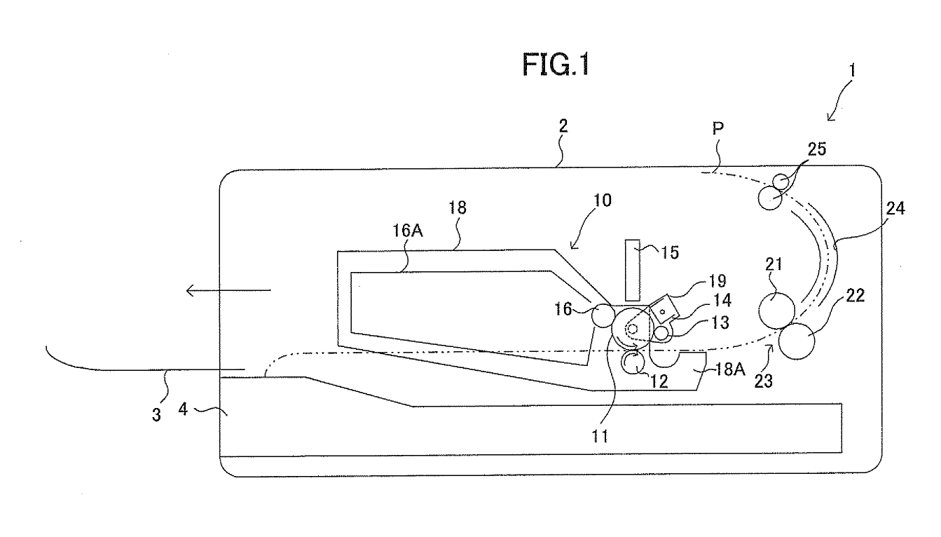

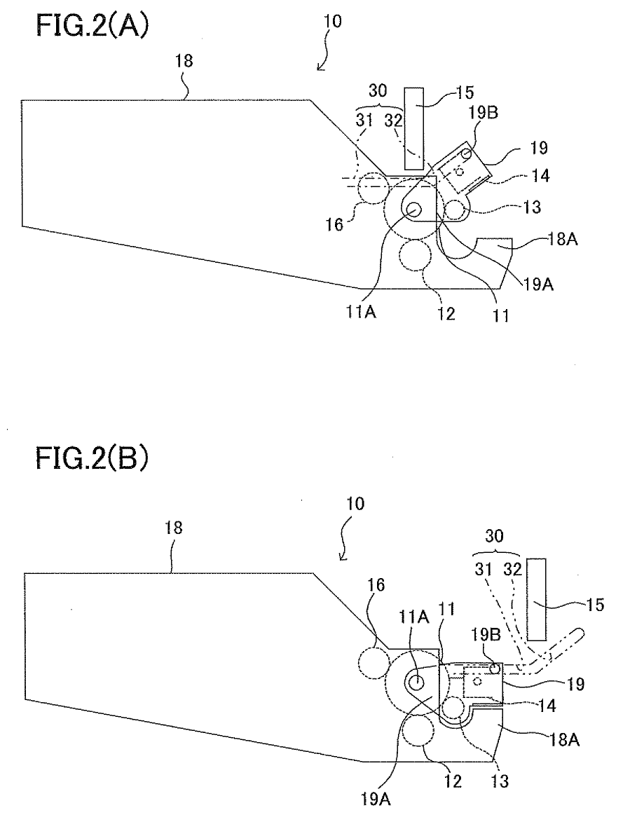

An image forming device according to a first embodiment of the present invention will be described with reference to FIGS. 1 through 2(B). The first embodiment pertains to a monochromatic laser printer. The terms “upward”, “downward”, “upper”, “lower”, “above”, “below”, “beneath”, “right”, “left”, “front”, “rear” and the like will be used throughout the description assuming that the image forming device is disposed in an orientation in which it is intended to be used.

The image forming device 1 includes a frame 2 having a front side provided with a door 3 which can be opened and closed. The front side is a side toward which a sheet P formed with an image is ejected. The frame 4 has a lower portion at which a sheet cassette 4 is movable in frontward/rearward direction. In the sheet cassette 4, a plurality of cut sheets is stacked. Various rollers including a sheet supply roller are provided for conveying each sheet in the sheet cassette 4 to a process cartridge 10 provided at an internal center portion of the frame 2.

The process cartridge 10 includes a photosensitive drum 11, a transfer roller 12, a cleaner 13, a charger 14, and a developing roller 16. Further, an LED array 15 is provided adjacent the process cartridge 10, i.e., adjacent to the photosensitive drum 11. The photosensitive drum includes a drum body grounded, and a photosensitive layer formed thereover and made from a positively chargeable material such as polycarbonade. The drum body includes a rotation shaft 11A as shown in FIG. 2(A). The photosensitive drum 11 is rotatable in a counterclockwise direction in FIG. 1. The transfer roller 12 is rotatably provided to nip the sheet P in cooperation with the photosensitive drum 11 for transferring a toner image on the photosensitive drum 11 onto the sheet P.

The cleaner 13, the charger 14, the LED array 15, and the developing roller 16 are disposed around the photosensitive drum 11 in the order from the transfer roller 12 in the rotating direction of the photosensitive drum 11. The cleaner 13 is in the form of a roller in rolling contact with the photosensitive drum 11 for removing residual toner (developer agent) remaining on the surface of the photosensitive drum 11. The charger 14 is a positively charging scorotron type charger having a tungsten wire from which a corona discharge occurs so as to uniformly charge the surface of the photosensitive drum 11 with positive polarity.

The LED array 15 is fixed to the frame 2 and includes a plurality of light emitting elements (LED array) arrayed in a lateral direction (widthwise direction of the sheet P) for exposing the outer peripheral surface of the photosensitive drum 11 to light in accordance with image data. The developing roller 16 is provided in a toner container 16A and is adapted for supplying positively chargeable non-magnetic single component type toner accumulated in the toner container 16A to the outer peripheral surface of the photosensitive drum 11 to form a positively charged thin toner layer thereover. The toner container 16A is detachably attached to the process cartridge 10 along with the developing roller 16. However, the toner container can be integral with the process cartridge 10 along with the developing roller.

After the cleaner 13 removes residual toner on the photosensitive drum 11 during its rotation, the surface of the photosensitive drum 11 is uniformly positively charged by the charger 14. Then, the surface is exposed to light by the LED array 15, whereupon electrostatic latent image based on the image data is formed on the surface of the photosensitive drum 11. The latent image area has a potential lower than that of the remaining portion.

Then, positively charged toner is supplied to the photosensitive drum 11 from the developing roller 16. As a result, a visible toner image corresponding to the electrostatic latent image is formed on the surface of the photosensitive drum 11.

The transfer roller 12 is rotatable in a clockwise direction in FIG. 1. The transfer roller 12 includes a roller shaft made from metal and a rubber layer formed over the roller shaft. The rubber layer is made from ion conductive rubber material. A transfer bias is applied to the transfer roller 12 so as to transfer the toner image onto the sheet P passing through the photosensitive drum 11 and the transfer roller 12. A fixing unit 23 including a heat roller 21 and a pressure roller 22 are provided. The toner image on the sheet P is thermally fixed when the sheet passes through the heat roller 21 and the pressure roller 22. A curved sheet discharge path 24 extends from the fixing unit 23 so as to direct the sheet P frontward. A discharge roller 25 is provided at an exit of the discharge path 24 to discharge the sheet P onto a discharge tray (not shown).

Next, details of the process cartridge 10 will be described. Operating position of the process cartridge 10 is shown in FIG. 2(A). The process cartridge 10 includes a first casing 18 in which the photosensitive drum 11, the transfer roller 12, and the developing roller 16 are rotatably supported. The first casing 18 includes a pair of side plates having rear upper portions serving as seat or stop portions 18A. The seat portions 18A also function as a part of the sheet passage at an operating state of the process cartridge 10. Operating state implies a state for performing image forming operation. The above-described toner container 18A is detachably assembled to the first casing 18.

The process cartridge 10 also includes a second casing 19 separate from the first casing 18 and made from highly rigid material. The cleaner 13 and the charger 14 are supported in the second casing 19. The second casing 19 is pivotally movable with respect to the first casing 18 to function as a pivotally movable member. The second casing 19 includes a pair of arms 19A positioned at laterally outward of the first casing 18. The rotation shaft 11A of the photosensitive drum 11 laterally protrudes outwardly from the first casing 18, and the pair of arms 19A is pivotally movably supported to the rotation shaft 11A such that the pair of arms 19A is angularly movable about an axis of the rotation shaft 11A.

The second casing 19 has lateral sides from which a pair of bosses 19B protrudes laterally outward. The frame 2 has lateral sides formed with a pair of guide grooves 30 so as to guide movement of the pair of bosses 19B therealong. Each guide groove 30 has a horizontal part 31 and a slanting part 32. The horizontal part 31 is positioned frontward of the slanting part 32. In the operating position of the process cartridge 10, the horizontal part 31 extends frontward from a position immediately below the LED array 15 fixed to the frame 2, and the slanting part 32 is bent from the horizontal part 31 upward toward rearward from the position immediately below the LED array 15.

In the operating position, the boss 19B reaches a rearmost end portion of the guide groove 30. In this state, the second casing 19 has been pivotally moved upward together with the charger 14 and the cleaner 13. Thus, the charger 14 is positioned behind and above the photosensitive drum 11 and away from a sheet path. Therefore, abutment of the sheet P against the charger 14 can be prevented, and degradation of the toner image on the sheet P by the discharge from the charger 14 can be restrained.

For detaching the process cartridge 10 from the frame 2, the second case 19 is pivotally moved downward because of the engagement between the boss 19A and the guide groove 30 upon pulling the cartridge 10 frontward. When boss 19A is brought into engagement with the horizontal part 31, the second casing 19 provides its posture capable of avoiding mechanical interference with the LED array 15. Further, in this case, the charger 14 is positioned rearward of the photosensitive drum 11, and the second casing 19 is seated on the seat portion 18A. Therefore, a posture of the second casing 19 is fixed to a non-interference position.

According to the above-described embodiment, mechanical interference between the charger 14 and the LED array 15 can be obviated without any displacement of the LED array 15. Further, since the second casing 19 can be seated on the seat portion 18A, the process cartridge 10 can be assembled into the frame 2 without any mechanical interference with the LED array 15. Moreover, cleaning to the components of the charger 14 such as the wire can be facilitated by maintaining the seating state of the second casing 19 onto the seat portion 18A.

Further, since the second casing 19 is pivotally movable about the rotation shaft 11A of the photosensitive drum 11, a constant gap between the outer peripheral surface of the photosensitive drum 11 and the charger 14 can be provided regardless of the pivotal position of the second casing 19. Accordingly, direct contact of the charger 14 with the surface of the photosensitive drum 11 can be obviated. Further, since the cleaner 13 and the charger 14 are supported to the second casing 19, the cleaner 13 and the charger 14 are moved concurrently with a constant gap therebetween. Thus, mechanical interference therebetween can be avoided.

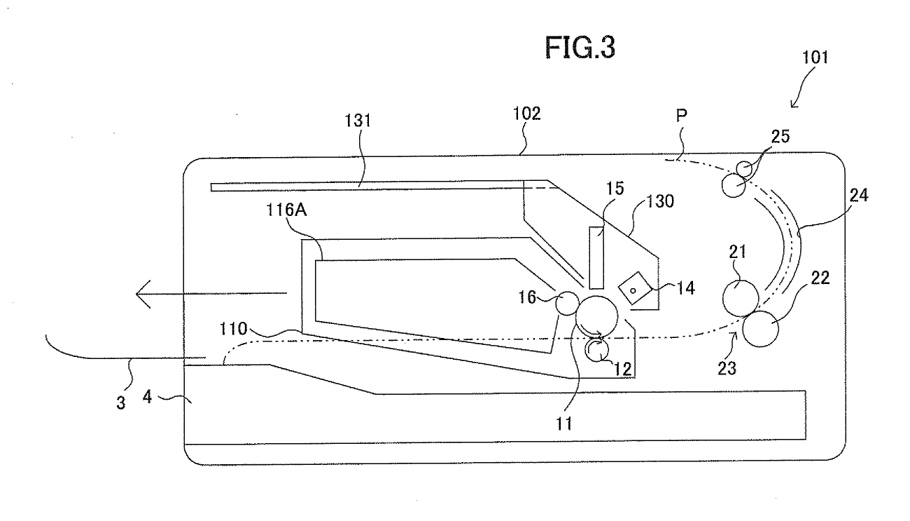

An image forming device according to a second embodiment of the present invention will be described with reference to FIG. 3 wherein like parts and components are designated by the same reference numerals as those shown in FIGS. 1 through 2(B).

In the image forming device 101 according to the second embodiment, a cleaner 13 is dispensed with. Further, a process cartridge 110 is detachably attached to the frame 102 and includes the photosensitive drum 11, the transfer roller 12 and the developing roller 16. In other words, the process cartridge 110 does not include the charger 14. Instead, an secondary cartridge 130 is provided in which the charger 14 and the LED array 15 are assembled. The secondary cartridge 130 functions as exposure and charger unit and is provided with a handgrip 131. The secondary cartridge 130 is detachably attached to the frame 102 through the handgrip 131 independent of the attachment and detachment of the process cartridge 110.

With such structure, the process cartridge 110 can be attached to and detached from the frame 102 without any mechanical interference between the charger 14 and the LED array 15, even if the LED array 15 is not moved.

Various modifications may be conceivable. For example, in the first embodiment, the second casing 19 is seated in the seat portion 18A. However, the charger 14 can be directly seated on the seat portion 18A. Further, the LED array 15 can be exchanged with a new LED array. Further, in the second embodiment, the cleaner is dispensed with. However, the cleaner 13 can be provided to the process cartridge 110 or the secondary cartridge 130. Further, in the second embodiment, a toner container 116A is detachably attached to the process cartridge 110 along with the developing roller 16. However, the toner container can be integral with the process cartridge 110 along with the developing roller. Further, shape of the process cartridge 10, 110 is not limited to the above described embodiments, but various configurations are conceivable.

While the invention has been described in detail with reference to the embodiments thereof, it would be apparent to those skilled in the art that various changes and modifications may be made therein without departing from the spirit and scope of the invention.

What is claimed is:

1. An image forming device comprising:
a frame having a front opening provided with a door;
a process cartridge detachably assembled in the frame and accessible through the front opening upon opening the door, the process cartridge comprising:
a first casing movably supported by the frame and having a seat portion;
a photosensitive drum disposed in the first casing and having an outer surface in which an electrostatic latent image is formable;
a second casing pivotally movably connected to the first casing and movable between a first position and a second position in accordance with push-in and pull-out movement of the first casing relative to the frame;
a charger disposed in the second casing for uniformly charging the photosensitive drum; aid
a developing roller disposed in the first casing for supplying charged developer agent to the photosensitive drum; and
an LED array supported to the frame and provided independent of the first casing and second casing for forming an electrostatic latent image on the photosensitive drum after the photosensitive drum is charged by the charger, the charger being positioned close to the LED array in the first position for image forming operation, and the charger being remote from the LED array in the second position for avoiding mechanical interference therewith, at least one of the second casing and the charger being seated on the seat portion in the second position.

2. The image forming device as claimed in claim 1, wherein the first casing is divided into a main section in which the photosensitive drum is disposed, and a subordinate section in which the developing roller is disposed, the subordinate section being detachably attached to the main section.

3. The image forming device as claimed in claim 1, wherein the photosensitive drum includes a rotation shaft, the second casing having a base end portion pivotally movable about the rotation shaft.

4. The image forming device as claimed in claim 1, further comprising a cleaner disposed in the second casing.

5. The image forming device as claimed in claim 1, wherein the frame has a pair of side walls, and each side wall is formed with a guide groove; and
wherein the second casing has a pair of side walls and each side wall is provided with a protrusion engaged with each guide groove for providing pivotal movement of the second casing in accordance with a push-in or pull-out movement of the first casing relative to the frame.

6. An image forming device comprising;
a frame having a front opening provided with a door;
a process cartridge detachably assembled in the frame and accessible through the front opening upon opening the door, the process cartridge comprising:
a casing movably supported by the frame;
a photosensitive drum disposed in the casing and having an outer surface in which an electrostatic latent image is formable; and
a developing roller disposed in the casing for supplying charged developer agent to the photosensitive drum;
a secondary cartridge case separate from the casing and detachably assembled in the frame and accessible through the front opening upon opening the door;
a charger disposed in the secondary cartridge case for uniformly charging the photosensitive drum; and
an LED array disposed in the secondary cartridge case for forming an electrostatic latent image on the photosensitive drum after the photosensitive drum is charged by the charger.

7. The image forming device as claimed in claim 6, wherein the casing is divided into a main section in which the photosensitive drum is disposed and a subordinate section in which the developing roller is disposed, the subordinate section being detachably attached to the main section.

8. The image forming device as claimed in claim 6, wherein the secondary cartridge case is provided with a handgrip that is accessible upon opening the door.

9. The image forming device as claimed in claim 6, further comprising a cleaner disposed in one of the casing and the secondary cartridge case.

10. A process cartridge to be detachably assembled in an image forming device having a frame and an LED array supported to the frame, the frame having a front opening provided with a door, the process cartridge being detachably assembled in the frame and accessible through the front opening upon opening the door, the process cartridge comprising:
a first casing movably supported by the frame and having a seat portion;
au photosensitive drum disposed in the first casing and having an outer surface in which an electrostatic latent image is formable;
a developing roller disposed in the first casing for supplying charged developer agent to the photosensitive drum;
a second casing pivotally movably connected to the first casing and movable between a first position and a second position; and
a charger disposed in the second casing for uniformly charging the photosensitive drum, the charger being positioned close to the LED array in the first position fox image forming operation, and the charger being remote from the LED array in the second position for avoiding mechanical interference therewith, at least one of the second casing and the charger being seated on the seat portion in the second position.

11. The process cartridge as claimed in claim 10, wherein the first casing is divided into a main section in which the photosensitive drum is disposed, and a subordinate section in which the developing roller is disposed, the subordinate section being detachably attached to the main section.

12. The process cartridge as claimed in claim 10, wherein the photosensitive drum includes a rotation shad, the second casing having a base end portion pivotally movable about the rotation shaft.

13. The process cartridge as claimed in claim 10, further comprising a cleaner disposed in the second casing.

14. The process cartridge as claimed in claim 10, wherein the frame has a pair of side walls, and each side wall is formed with a guide groove; and
wherein the second casing has a pair of side walls and each side wall is provided with a protrusion engaged with each guide groove for providing pivotal movement of the second casing in accordance with a push-in or pull-out movement of the first casing relative to the frame.

15. A combination of a process cartridge and an secondary cartridge to be detachably assembled in an image forming device having a frame, the frame having a front opening provided with a door;
the process cartridge comprising:
a casing movably supported by the frame and detachably assembled in the frame and accessible through the front opening upon opening the door,
a photosensitive drum disposed in the casing and having an outer surface in which an electrostatic latent image is formable; and
a developing roller disposed in the casing for supplying charged developer agent to the photosensitive drum; and
the secondary cartridge comprising:
a secondary cartridge case separate from the casing and detachably assembled in the frame and accessible through the front opening upon opening the door;
a charger disposed in the secondary cartridge case for uniformly charging the photosensitive drum; and
an LED array disposed in the secondary cartridge case for forming an electrostatic latent image on the photosensitive drum after the photosensitive drum is charged by the charger.

16. The combination as claimed in claim 15, wherein the casing is divided into a main section in which the photosensitive dr is disposed and a subordinate section in which the developing roller is disposed, the subordinate section being detachably attached to the main section.

17. The combination as claimed in claim 15, wherein the secondary cartridge case is provided with a handgrip that is accessible upon opening the door.

18. The combination as claimed in claim 15, further comprising a cleaner disposed in one of the casing and the secondary cartridge case.
